(19) United States
(12) Patent Application Publication
(10) Pub. No.: US 2026/0329111 A1
(43) Pub. Date: Oct. 22, 2026

(54) Eyewear with Inwardly Biased Temples

(71) Applicant: Jon Scott Butler, Lakeland, FL (US)

(72) Inventor: Jon Scott Butler, Lakeland, FL (US)

(21) Appl. No.: 19/656,152

(22) Filed: Apr. 23, 2026

Related U.S. Application Data
(63) Continuation-in-part of application No. 18/641,721, filed on Apr. 22, 2024, now Pat. No. 12,638,693.

(51) Int. Cl. G02C 5/22; G02C 5/00; G02C 5/14; G02C 5/16

(52) U.S. Cl. CPC G02C 5/2281; G02C 5/008; G02C 5/146; G02C 5/16; G02C 5/2227; G02C 2200/28

(57) ABSTRACT

Disclosed is a pair of glasses with inwardly biased temples that can frictionally secure the glasses over the temples of a wearer. This allows the temples to be shorter in length and eliminates the need for the temples to be secured to the ears. The biasing of the temples is achieved, in one embodiment, via torsion springs integrated into the hinges of the glasses.

### CROSS REFERENCE TO RELATED APPLICATIONS

This is a continuation-in-part of and claims priority to co-pending U.S. patent application Ser. No. 18/641,721, filed on Apr. 22, 2024, and entitled “Eyewear with Inwardly Biased Temples,” which is a continuation-in-part of and claims priority to U.S. patent application Ser. No. 18/108,118, filed on Feb. 10, 2023, and entitled “Eyewear with Inwardly Biased Temples.” The contents of these applications are fully incorporated herein for all purposes.

### TECHNICAL FIELD

This disclosure relates to glasses that are worn on a user's temples. More particularly, the present disclosure relates to glasses with inwardly biased temple pieces that do not engage the user's ears.

### BACKGROUND OF THE INVENTION

Current eyewear employs a design that traces its origin to the 13th century. This design includes a frame that houses one or more lens, a nose bridge, and pivotal temple pieces that engage the user's ears. This well-known design can be used for prescription lenses, magnifiers, bifocals, trifocals, or sunglasses. This design features frames that rest upon the bridge of the user's nose as well as the user's ears.

Various efforts have been employed over the years to improve upon this design. One such effort is disclosed in U.S. Patent Application Publication No. 2021/0080747 to Ragonese. Ragonese discloses a pivotable eyeglass frame with a shortened temple bar with suction cups for holding the temple portion to a user's face. The suction cups also allow the glasses to pivot from a normal position to a raised position. Additionally, U.S. Pat. No. 9,134,544 to Rochford et. al. discloses eyeglasses with a front frame portion and first and second side portions extending from opposite sides of the front frame. The side portions of Rochford are configured to end at a user's temples. The temples can be mounted via a flexible living hinge. Further, U.S. Pat. No. 7,165,838 to Sapp discloses tensioning eyewear. The eyewear includes truncated temple members that are secured via a temple hinge assembly. Separate expandable elastic and padded band members tension about the user's face and are attached to the temple members.

Additionally, U.S. Pat. No. 2,814,968 to Nixon discloses glasses with short temples not substantially longer than the width of the lens rims. The temples are stopped, when unfolded, at ninety-degree angles to the lens rims, in positions to exert pressure upon the temples of a wearer. However, the glasses disclosed by Nixon do not include a way to adjust the pressure exerted upon the temples of a wearer.

Although each of the foregoing designs accomplishes its own unique objective, they all suffer from common drawbacks. For example, they do not provide a pair of glasses with shortened temple pieces that are inwardly biased to secure the glasses to the head of the wearer in which the degree of inward bias is precisely adjustable by the wearer. The ability of a user to precisely adjust the degree of inward bias can improve wearer comfort and allow for customizability to the end user. It is an object of the present disclosure to provide a pair of glasses that overcomes this drawback.

### SUMMARY OF THE INVENTION

It is an object of the present disclosure to provide a pair of glasses that can be secured to a user's head without the glasses engaging or touching the user's ears.

It is another an object of the present disclosure to provide eyewear with inwardly biased temple members with the biasing force being sufficient to retain the glasses in position.

It is still yet another object of the present disclosure to provide eyewear with biased temple members, wherein the biasing is provided by torsion springs mounted within the hinges of the glasses.

Another object of the present disclosure is to provide glasses that employ a compact design and that a user can take on or off with minimal effort.

These and other objects of the invention can be achieved via a pair of eyeglasses that include a frame with opposing ends, a pair of lens openings, and a nose bridge. A mounting aperture and a recess are positioned within each end of the frame. The eyeglasses also include a pair of temple pieces, with each temple piece including a protrusion that is fitted into one of the recesses of the frame. A pair of pins are utilized to mount the temple pieces to the frame. Specifically, each pin is positioned within one of the mounting apertures of the frame to hingedly connect one of the temple pieces to the frame. A pair of torsion springs provide the biasing force. Each torsion spring includes a first end mounted within one of the temple pieces and a second end mounted within the frame. Thus, the torsion springs bias the temple pieces inwardly to secure the frame over the temples of a wearer.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a front elevational view of the eyeglasses of the present disclosure.

FIG. 2 is a top plan view of the eyeglasses of the present disclosure.

FIG. 3 is a side perspective view of the eyeglasses of the present disclosure.

FIG. 4 is a rear perspective view of the eyeglasses of the present disclosure.

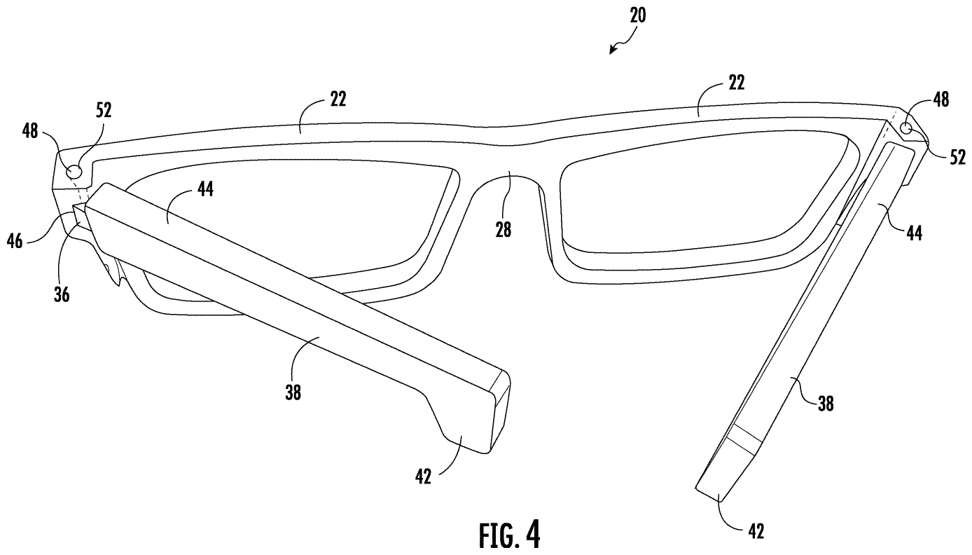

FIG. 5 is a top plan view of a second example of the eyeglasses of the present disclosure.

FIG. 6 is a top view of a hinge of the eyeglasses of FIG. 5, wherein the set screw is screwed all the way in.

FIG. 7 is a top view of the hinge of the eyeglasses of FIG. 5, wherein the set screw is screwed all the way out.

FIG. 8 is a top view of the hinge of the eyeglasses of FIG. 5, wherein the set screw is screwed all the way out and the temple piece is folded inward and does not contact the set screw.

Similar reference numerals refer to similar parts throughout the several views of the drawings.

Parts List

| | |
|---|---|
| 20 | Glasses |
| 22 | Frame |
| 24 | Ends of Frame |
| 26 | Lens Openings |
| 28 | Nose Bridge |
| 32 | Hinge Assemblies |
| 34 | Mounting Apertures |
| 36 | Recesses |
| 38 | Temple Pieces |
| 42 | First End of Temple Piece |
| 44 | Second End of Temple Piece |
| 46 | Protrusions from Temple Pieces |
| 48 | Pins |
| 52 | Upper Head of Pin |
| 54 | Lower Body of Pin |
| 56 | Torsion Springs |
| 58 | Central Portion of Torsion Spring |
| 62 | First End of Torsion Spring |
| 64 | Second End of Torsion Spring |
| 75 | Set Screw |
| 85 | Stop Face |

### DETAILED DESCRIPTION OF THE DRAWINGS

The present disclosure relates to a pair of glasses with inwardly biased temple pieces that can frictionally and positively secure the glasses over the temples of a wearer. This allows the temple pieces to be shorter in length and eliminates the need for the temple pieces to be secured over the ears. The biasing of the temple pieces is achieved, in one embodiment, via torsion springs integrated into the hinges of the glasses. In another embodiment, the biasing of the temple pieces is achieved via flexibility and resiliency of the temple pieces themselves. The degree of biasing of a temple piece is precisely adjustable via a set screw that restrains outward rotation of the temple piece relative to the frame. The various features of the present disclosure, and the manner in which they interrelate, are described in greater detail hereinafter.

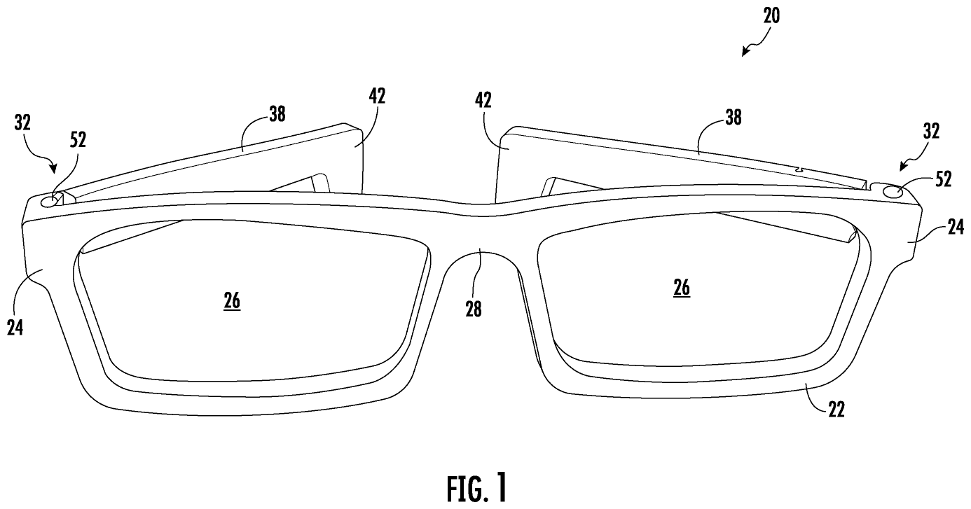

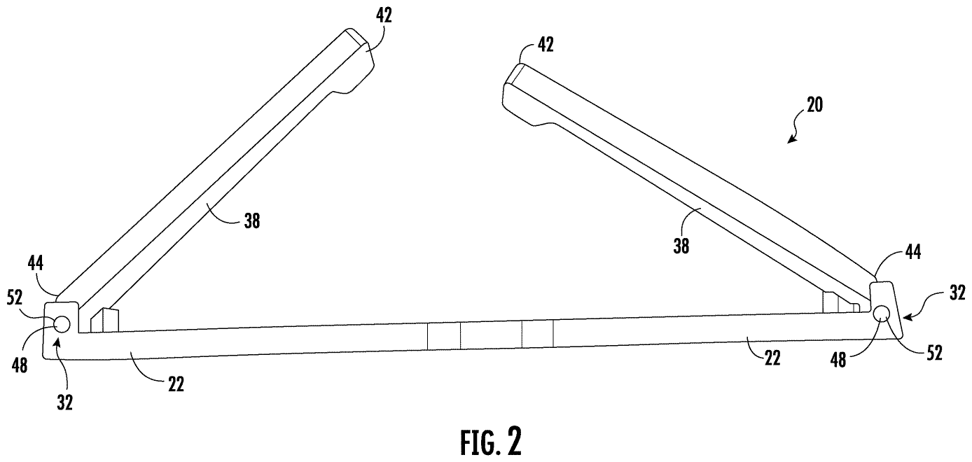

FIG. 1 illustrates a first example of the glasses 20 of the present disclosure. As illustrated, glasses 20 include a primary frame 22 that is adapted to be positioned in front of the eyes of the wearer. Frame 22 is defined by opposing ends 24, a pair of lens openings 26, and a centrally located nose bridge 28. Hinge assemblies 32 are included at each opposing end 24. These features of the glasses are the same as conventional glasses and allow for the mounting of prescription lenses, magnifier lenses, bifocals, trifocals, or sunglasses. FIG. 2 illustrates that each end 24 of frame 22 includes a mounting aperture 34 and a recess 36. Mounting aperture 34 and recess 36 allow for opposing temple pieces 38 to be hingedly mounted via hinge assemblies 32 as described below.

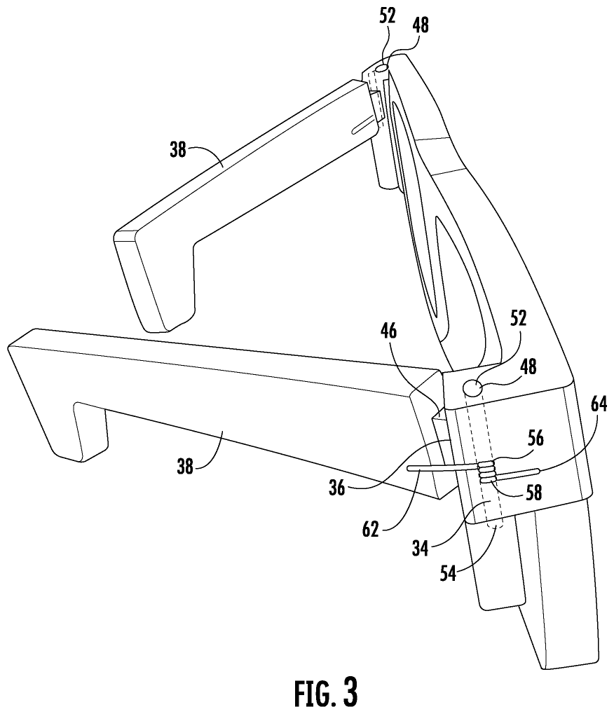

FIG. 2 also illustrates the pair of temple pieces 38 that are attached to frame 20. These temple pieces 38 are of a shortened length. In a preferred but non-limiting embodiment, each temple piece 28 is between 2 to 3 inches in length, with a preferred length of approximately 2.5 inches. Each temple piece 38 has a first angled end 42 adapted to rest on a temple of the wearer. Although an angled end 42 is depicted, the end can be formed into any of a variety of shapes or configurations. Indeed, the biased nature of the temple pieces 38 allows them to be straight, and without any angle or bend. In the example of FIG. 3, the angled end 42 includes a fin 43 protruding downwardly therefrom. Notably, the first end 42 of each temple piece 38 does not extend over the ear of the wearer. Each temple piece 38 also has a second end 44. As illustrated in FIG. 3, each second end 44 has a protrusion 46 that is dimensioned to fit within a corresponding recess 36 within frame 22. This allows each end 44 of each temple piece 38 to be pivotally secured to frame 22. This pivotal connection if facilitated by a pair of pins 48. Each pin 48 includes an upper head 52 and a lower body 54. The body 54 of each pin 48 is positioned within one of the mounting apertures 34 of frame 22 to hingedly connect one of the temple pieces 38 to the frame 22.

The two temple pieces 38 are biased inwardly via a pair of torsion springs 56. Each of these torsion springs 56 has a central portion 58 that is positioned about the body of one of the pins 48. Each torsion spring 56 further includes a first end 62 mounted within one of the temple pieces 38 and a second end 64 mounted within the frame 22. In the depicted embodiment, the first end 62 of each spring 56 is fully embedded within a lower extent of the temple piece 38. Similarly, the second end 64 of each temple piece is preferably secured within a central extent of frame 22. Thus, the torsion springs 56 biases the temple pieces 38 inwardly to secure the frame 22 over the temples of a wearer. Ideally each spring 56 exerts a sufficient amount of force to secure its associated temple piece 38 to the check bone of the wearer. This force can be adjustable by the springs as needed.

In an example embodiment, each torsion spring 56 includes biased and unbiased states. Furthermore, the orientation of each spring 56 is such that, while in the unbiased state, each temple piece 38 forms an angle of approximately 30 degrees relative to the frame 22. This unbiased state is best illustrated in FIG. 2. As shown in FIG. 2, the angled ends 42 of the temple pieces 38 do not contact each other when the temple pieces 38 are positioned at approximately 30 degrees relative to the frame. Thereafter, the user can move the temple pieces 38 into a biased state. This can be done by pushing the temple pieces 38 inwardly and into contact frame 22. This may be a preferred orientation to place glasses 20 into a container or sleeve for storage or transport. However, temple pieces 38 can also be biased outwardly, such as when the user places glasses 20 over their face. In this orientation, temple pieces 38 contact the temples of the wearer and remain in a biased state, with the spring force serving to secure glasses 20. After removing glasses 20, the temple pieces 38 will return to the unbiased state forming a 30 degree angle relative to frame 22. This unbiased orientation has the advantage of positioning the temple pieces 38 for easy access by the wearer.

### Second Example

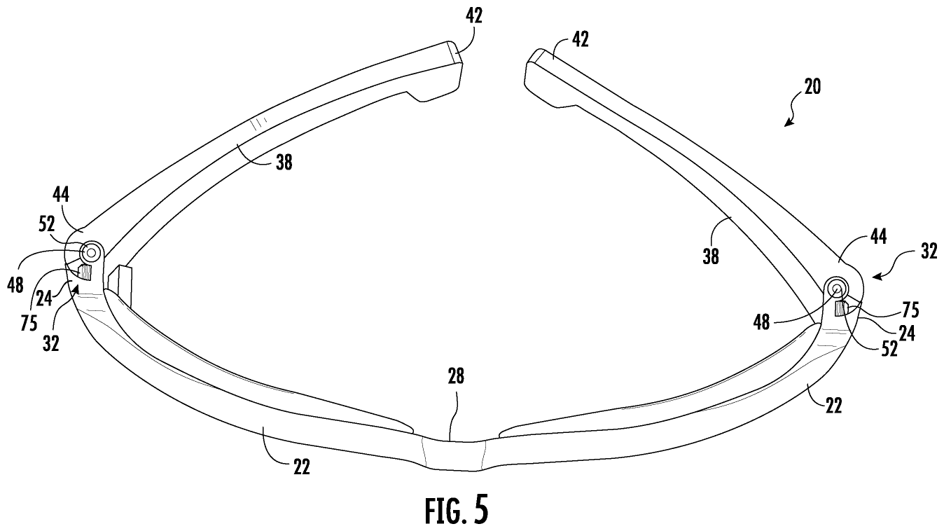

Referring now to FIGS. 5-8, a second example of the eyeglasses of the present disclosure is shown. As compared to the first example, the hinge assemblies 32 operate differently and provide different advantages.

Referring to FIG. 5, the frame 22 of the second example bows outwardly, unlike in the first example presented above. The frame 22 is flexible and resilient. As used herein, “flexible” with respect to an object means the object is capable of significant elastic deformation; and “resilient” with respect to an object means the object tends to return to its initial shape when elastically deformed and is thereby able to exert a spring force when elastically deformed. The frame 22 has a first end 24 and a second end 24. The first end 24 and second end 24 each define a junction. In the example shown, the junctions are receivers and are hinge assemblies 32. The frame 22 defines a nose bridge 28 between the first end 24 and the second end 24. The frame 22 defines a first lens opening housing a first lens between the first end 24 and the nose bridge 28; and a second lens opening housing a second lens between the second end 24 and the nose bridge 28. The frame has an exterior surface.

The temple pieces 38 have a first anchoring end 42 and a second pivot end 44. A midsection is between the first anchoring end 42 and the second pivot end 44. The temple pieces 38 are bowed outwardly. The temple pieces 38 are flexible and resilient. The second pivot ends 44 of the temple pieces 38 are pivotally connected to the frame 22 via pins 48. The temple pieces 38 can pivot around the pins 48 and be moved pivotally outward (away from the frame 22) and inward (toward the frame 22).

An anchoring end 42 of a temple piece 38 fits at least partially within the temple of a user when the anchoring end 42 is pressed against the temple of the user in such a way that the anchoring end 42 is anchored by the concavity of the temple. The first anchoring end 42 is wider than the midsection to allow the first anchoring end 42 to exert a sufficient force on the temples of a wearer to hold the glasses 20 in place with minimal pressure. In the example shown, the first anchoring end 42 includes a downwardly protruding fin. In other examples, the first anchoring end 42 may have a round or ovular shape, a paddle shape, or the like. In the example shown, the temple pieces 38 have a length of 2-4 inches. In other examples, the length may be no greater than 4 inches, 2-3 inches, 2 inches, 3 inches, 2.5 inches, 3.5 inches, or another desired length. The length should be small enough that the first anchoring end 42 of the temple piece 38 does not contact an ear of the wearer when the glasses 20 are worn and the glasses 20 are as compact as possible, but large enough that the first anchoring end 42 of the temple piece 38 can contact the temple of the wearer when the glasses 20 are worn.

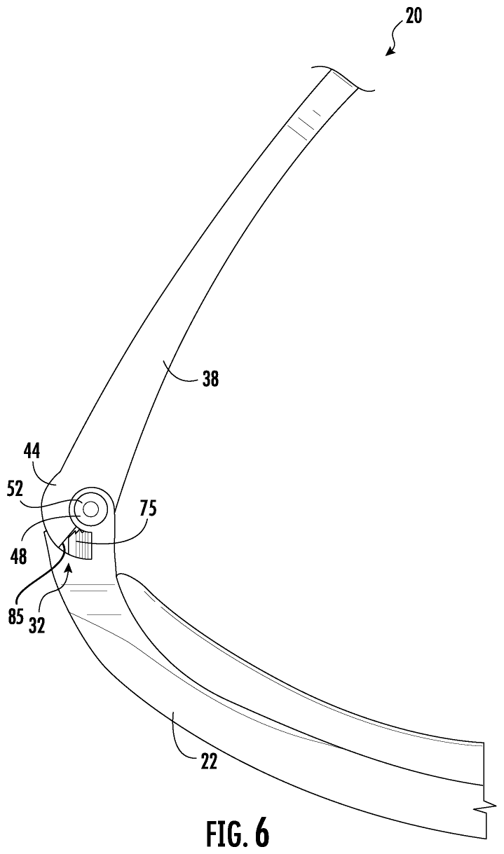

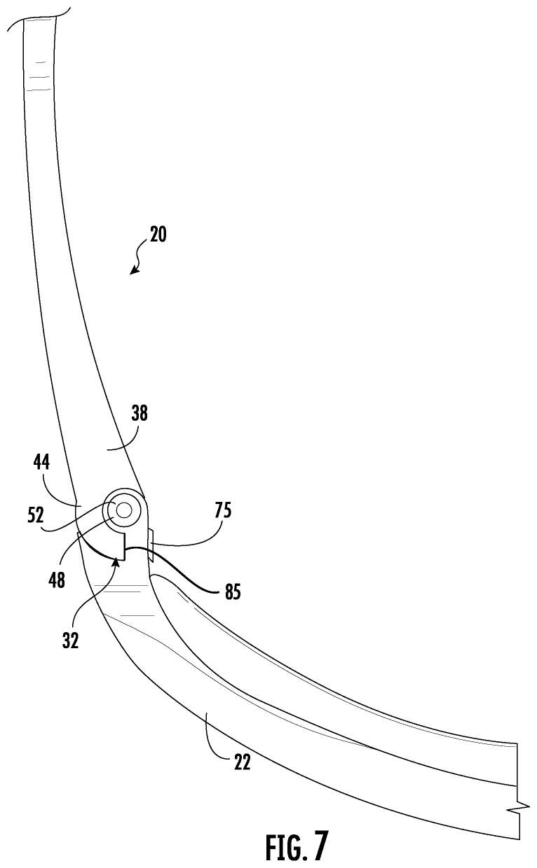

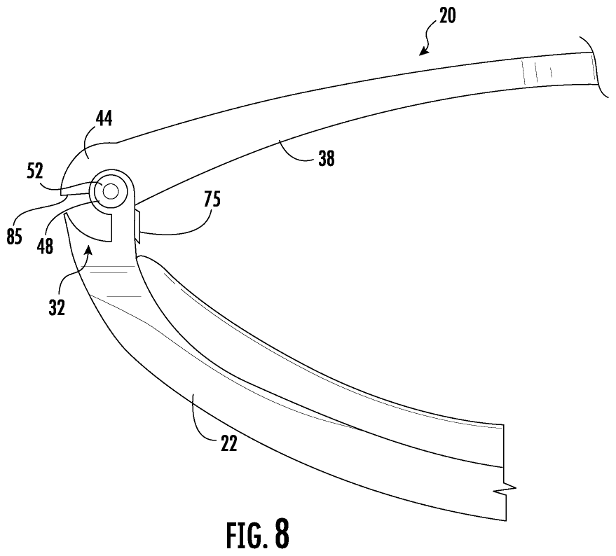

Referring to FIG. 6-8, the second pivot ends 44 of the temple pieces 38 define stop faces 85. The hinge assemblies 32 define adjustment zones. In the example shown, the adjustment zones are cavities in the frame 22 adjacent and around the pins 48 in which the second pivot ends 44 and stop faces 85 of the temple pieces 38 travel. The glasses 20 include pivot adjusters. A pivot adjuster adjustably limits the angular range over which an associated temple piece 38 can pivot. In the example shown, the pivot adjusters are set screws 75. In the example shown, the set screws 75 have hex drives and can be manipulated using a hex driver, such as an Allen key. In other examples, the set screws 75 may be manipulable without any additional tools, may have drives including one or more of: internal drives such as slotted (“flat”), Phillips, Pozi, hex, torx, and square, and external drives such as hexagonal, knurled, triangular, and the like. The hinge assemblies 32 define screw holes. In the example shown, the screw holes extend from the adjustment zones to the exterior surface of the frame 22. Set screws 75 extend through the screw holes. The set screws 75 can be screwed into and out of the screw holes. Screwing a set screw 75 into a screw hole moves an end of the set screw 75 further into the adjustment zone. Screwing a set screw 75 out of a screw hole moves the end of the set screw 75 further out of the adjustment zone. FIG. 6 shows the set screw 75 screwed all the way into the screw hole such that the end of the set screw 75 at its furthest extent into the adjustment zone. FIGS. 7-8 show the set screw 75 screwed further out of the screw hole such that the end of the set screw 75 is not within the adjustment zone. When a temple piece 38 pivots around an associated pin 48, the stop face 85 of the second pivot end 44 of the temple piece 38 moves within the adjustment zone. FIG. 7 shows the position of the stop face 85 when the temple arm 38 is folded outward. FIG. 8 shows the position of the stop face 85 when the temple arm 38 is folded inward.

Still referring to FIGS. 6-8, the set screws 75 adjustably limit the angular range over which the temple arms 38 can pivot. The ends of the set screws 75 extend further into or out of the adjustment zones depending on how far the set screws 75 are screwed into their respective screw holes. As shown in FIG. 6, when the set screw 75 is screwed relatively further into the screw hole, and the end of the set screw 75 extends relatively further into the adjustment zone, the range over which the temple arm 38 can pivot is limited to a relatively smaller angular range because the stop face 85 contacts the end of the set screw 75 at an earlier point as the temple arm 38 is pivoted outward. As shown in FIG. 7, when the set screw 75 is screwed relatively further out of the screw hole, and the end of the set screw 75 extends relatively less far into the adjustment zone, the range over which the temple arm 38 can pivot is limited to a relatively larger angular range because the stop face 85 contacts the end of the set screw 75 at a later point—or does not contact the end of the set screw 75 at all—as the temple arm 38 is pivoted outward. By this mechanism, the angular ranges over which the temple arms 38 can pivot are easily adjustable by a user by screwing the set screws 75 into or out of the screw holes.

Referring to FIGS. 5-8, in this example of the eyeglasses, the temple pieces 38 are not biased inwardly by torsion springs. Rather, the temple pieces 38 and/or the frame 22 are flexible and resilient. When the temple pieces 38 are stretched apart, the temple pieces 38 and/or the frame 22 elastically deform and act analogously to springs. The temple pieces 38 and/or the frame 22 tend to return to their original shape, resulting in an inward bias on the temple pieces 38. When the temple pieces 38 are stretched apart and placed on temples of a wearer, the inward bias can secure the glasses 20 to the wearer's head. As stated, the angular range over which the temple pieces 38 can pivot is easily adjustable by a user. This allows the user to easily adjust the tension of the glasses 20 on the user's temples. A relatively smaller angular range results in a relatively tighter fit of the glasses 20 on the user's temples, because the temple arms 38 must be elastically deformed to a greater degree in order to separate the second anchor ends 42 of the temple pieces 38 by the same distance.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. Eyewear comprising:
a frame with a junction;
a temple piece having a length no greater than 4 inches, a pivot end pivotally connected to the junction, and an anchor end opposite the pivot end; and
a pivot adjuster that adjustably limits outward pivotal movement of the temple piece.

2. The eyewear of claim 1, wherein the temple piece is flexible and resilient.

3. The eyewear of claim 1, wherein the frame is flexible and resilient.

4. The eyewear of claim 1, wherein the temple piece is bowed outwardly.

5. The eyewear of claim 1, wherein the frame is bowed outwardly.

6. The eyewear of claim 1, further comprising lenses attached to the frame.

7. The eyewear of claim 1, wherein the pivot adjuster is a screw.

8. The eyewear of claim 7, wherein:
the junction defines a screw hole; and
the screw is screwed into the screw hole.

9. The eyewear of claim 7, wherein an end of the screw limits outward pivotal movement of the temple piece by contacting the pivot end.

10. Eyewear comprising:
a frame with a first junction and a second junction opposite the first junction;
a first temple piece connected to the first junction;
a second temple piece connected to the second junction in such a way that the second temple piece can pivot outward and inward with respect to the frame;
the first temple piece and second temple piece having respective lengths no greater than 4 inches; and
a pivot adjuster that adjustably limits pivoting of the second temple piece.

11. The eyewear of claim 10, wherein the second temple piece is flexible and resilient.

12. The eyewear of claim 10, wherein the frame is flexible and resilient.

13. The eyewear of claim 10, wherein the second temple piece is bowed outwardly.

14. The eyewear of claim 10, wherein the frame is bowed outwardly.

15. The eyewear of claim 10, further comprising lenses attached to the frame.

16. The eyewear of claim 10, wherein the pivot adjuster is a screw.

17. The eyewear of claim 16, wherein:
the second junction defines a screw hole; and
the screw is screwed into the screw hole.

18. The eyewear of claim 16, wherein an end of the screw limits outward pivotal movement of the second temple piece by contacting the second temple piece.

19. The eyewear of claim 10, wherein the second temple piece includes an anchoring end.

20. A pair of eyeglasses for a wearer, the pair of eyeglasses being adjustable by the wearer, the pair of eyeglasses comprising:
a frame, the frame being flexible, resilient, and bowed outwardly and having a first end defining a receiver, a second end, a nose bridge between the first end and the second end, a first lens between the first end and the nose bridge, a second lens between the second end and the nose bridge, and an exterior surface;
the receiver defining an adjustment zone and a screw hole extending from the adjustment zone to the exterior surface of the frame;
a temple piece, the temple piece being flexible and resilient and having a first anchoring end, a second pivot end, and an outwardly bowed midsection therebetween, the second pivot end defining a stop face and being pivotally connected to the receiver via a pin in such a way that the second pivot end can pivot around the pin and the stop face can move through the adjustment zone;
the temple piece having a length of 2-4 inches;
a set screw extending through the screw hole in such a way that screwing the set screw into the screw hole moves an end of the set screw further into the adjustment zone, and screwing the set screw out of the screw hole moves the end of the set screw further out of the adjustment zone, such that the end of the set screw adjustably limits movement of the second pivot end of the temple piece within the adjustment zone by contacting the stop face at a point adjusted by the wearer.
